(19) United States
(12) Patent Application Publication
(10) Pub. No.: US 2016/0082967 A1
(43) Pub. Date: Mar. 24, 2016

(54) METHOD AND SYSTEM FOR PREVENTING OVERHEATING OF CLUTCH BY MEANS OF FORCIBLE CREEPING

(71) Applicants: Hyundai Motor Company, Seoul (KR); Kia Motors Corp., Seoul (KR)

(72) Inventors: Jeong Heon KAM, Seongnam-si (KR); Jin Sung KIM, Suwon-si (KR); Hyun Chul KIM, Suwon-si (KR)

(73) Assignees: Hyundai Motor Company, Seoul (KR); Kia Motors Corp., Seoul (KR)

(21) Appl. No.: 14/561,079

(22) Filed: Dec. 4, 2014

(30) Foreign Application Priority Data
Sep. 24, 2014 (KR) 10-2014-0127432

(51) Int. Cl. B60W 30/18

(52) U.S. Cl. CPC B60W 30/18063; B60W 2550/142

(57) ABSTRACT

Disclosed are methods and systems for preventing overheating of a clutch by means of forcible creeping. A method may include determining whether a vehicle is in a hill-hold mode, comparing an inclination of a slope where the vehicle is with a predetermined reference inclination, and leading a driver to depress a brake pedal by starting an uphill creeping mode, when the inclination of the slope is within a range where the vehicle is maintained in the hill-hold mode.

### CROSS REFERENCE TO RELATED APPLICATION

The present application claims priority of Korean Patent Application Number 10-2014-0127432 filed on Sep. 24, 2014, the entire contents of which application are incorporated herein for all purposes by this reference.

### BACKGROUND OF THE INVENTION

1. Field of the Invention

The present invention, in general, relates to a method and a system for preventing overheating of a clutch by means of forcible creeping, and, more particularly, to a method and a system for preventing overheating of a clutch by means of forcible creeping which can prevent a clutch from overheating by forcing the vehicle in a hill-hold state to creep to lead a driver to depress a brake pedal when forcible creeping is started, in order to prevent overheating of a clutch due to continuous slip when a driver maintains a vehicle in a hill-hold state using only an accelerator pedal on a slope.

2. Description of the Related Art

Hill-hold and creeping of a vehicle on a slope are described hereafter to help understand the present invention.

Drivers of vehicles equipped with an automatic transmission (AT, DCT, AMT etc.) maintain a ‘hill-hold’ state on an uphill road using only an accelerator pedal (with a brake pedal released) to prevent the vehicles from rolling backward.

In order to maintain the ‘hill-hold’ state, there is no specific problem in automatic transmission vehicles, because those vehicles are equipped with a torque converter, but in vehicles equipped with a DCT (Double Clutch Transmission) and an AMT (Automated Manual Transmission), the clutch is overheated by continuous slipping.

As known in the art, a clutch slip occurs when a vehicle is rapidly accelerated or is not accelerated on an uphill road due to idling of an engine, in which the friction force of a clutch is insufficient, so the engine power is not transmitted.

That is, drivers of vehicles equipped with a DCT or an AMT have a tendency to maintain a hill-hold state only by depressing the accelerator pedal on an uphill road, in which the clutch is overheated due to a continuous slip.

In a double clutch transmission of the related art, unlike an automatic transmission, two double clutches are connected to input shafts without a torque converter, the input shafts are connected to output shafts, respectively, and the output shafts are engaged with one differential gear. Accordingly, in order to start a vehicle from a stop, a state the same as half clutch of a manual transmission is required to transmit power and there is a need for controlling a clutch slip to maintain this state.

When a vehicle is restarted up a slope (up-hill driving) after being stopped or parked on the slope, a larger load is applied to a vehicle, in comparison to a flatland situation, in which friction between clutches of a double clutch transmission is unavoidable and non-linear response characteristics of the contact surfaces between the clutches give the driver an unpleasant sensation.

Further, when a clutch slips, heat due to friction has an influence on damage to the clutch, and wear due to slip and friction may also be a main factor reducing durability of the clutch.

Such a double clutch transmission also involves the problem that a vehicle may roll backward, when a clutch slip is not appropriately controlled or when the friction ability of the contact surface of a clutch is poor due to wear.

On the other hand, in order to prevent overheating of the clutch of vehicles equipped with a DCT or an AMT on an uphill road in the related art, a driver is led to depress the brake pedal by warning the driver with a sound generated by vibration of the vehicle or letting the vehicle roll backward by disengaging the clutch.

However, such a control logic of letting a vehicle roll backward by disengaging the clutch and leading a driver to depress the brake pedal to prevent the backward rolling is disadvantageous in terms of commercial value of a vehicle.

On the other hand, ‘creeping’ means, as well known in the art, driving without a vehicle rolling backward on an uphill road by maintaining a predetermined friction force against the uphill road, even if an accelerator pedal and a brake pedal are not depressed. When a driver depresses the accelerator pedal with a predetermined friction force maintained, the friction force is naturally removed and the vehicle starts normally operating.

Accordingly, the present invention provides a method and a system for preventing overheating of a clutch due to a clutch slip by forcibly changing a hill-hold mode into a creeping mode of a vehicle equipped with a DCT or an AMT on an uphill road having a predetermined inclination and by stopping a driver from maintaining a hill-hold state using only an accelerator pedal.

There are a related art, titled “Method and apparatus for controlling slopping road of hybrid electrical vehicle” and a related art, titled “A slip preventing device of a double clutch transmission and control method thereof”.

According to the “Method and apparatus for controlling slopping road of hybrid electrical vehicle”, when a hybrid vehicle is restarted with an engine clutch disengaged after stopping on a slope having an inclination over a predetermined level, the pressure of the engine clutch is increased to the maximum and then the vehicle is driven by an electric motor and a power generator, so that it is possible to prevent wear of the engine clutch due to frequent engaging and disengaging and it is also possible to prevent an increase in temperature of engine clutch oil, but it is far from the present invention in terms of a control logic for preventing the overheating of a clutch.

Further, according to “A slip preventing device of a double clutch transmission and control method thereof”, there are provided a one-way clutch and a clutch or a brake between an output shaft of a double clutch transmission and the transmission case, so that when being stopped or restarted on a slope, a vehicle is prevented from rolling backward by the one-way clutch restricting rotation of the output shaft to let the vehicle roll backward, and particularly, it can get rid of a driver's anxiety on a slope; however, it is also far from the control logic of the present invention for leading a driver to depress a brake pedal through forcible creeping.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Accordingly, the present invention has been made keeping in mind the above problems occurring in the related art and/or other problems, and the present invention is intended to provide a method and a system for preventing overheating of a clutch by means of forcible creeping which prevent a clutch from overheating by forcing a vehicle in a hill-hold state to creep so as to lead a driver to depress an accelerator pedal, in order to solve the problem of the overheating of a clutch when a driver depresses only an accelerator pedal to maintain a vehicle equipped with a DCT or an AMT in a hill-hold state on an uphill road.

The present invention provides a method of preventing overheating of a clutch by means of forcible creeping.

According to various aspects of the present invention, there is provided a method of preventing overheating of a clutch by means of forcible creeping. The method includes: determining, by a controller, whether a vehicle is in a hill-hold mode; comparing, by the controller, an inclination of a slope where the vehicle is with a predetermined reference inclination; and leading, by the controller, a driver to depress a brake pedal by starting an uphill creeping mode, when the inclination of the slope is within a range where the vehicle is maintained in the hill-hold mode.

In the determining of whether the vehicle is in the hill-hold mode, it may be determined that the vehicle is in the hill-hold mode, when a brake-off signal and an accelerator-on signal are sensed and the vehicle runs under a predetermined first reference speed over a predetermined time on the slope having the inclination over a predetermined first reference inclination.

In the comparing of the inclination of the slope where the vehicle is with the predetermined reference inclination, the driver may be warned by a sound for preventing the overheating of the clutch, when the inclination of the slope where the vehicle is positioned is larger than the reference inclination.

After the driver is warned by the sound generated by vibration of the vehicle, the hill-hold mode of the vehicle may be stopped, when the inclination of the slope where the vehicle is positioned is under a predetermined second inclination, a brake-on signal is sensed, or a vehicle speed is over a predetermined second reference speed.

In the starting of the uphill creeping of a vehicle, predetermined torque may be transmitted to a transmission and the driver may be led to depress the brake pedal.

After the starting of the uphill creeping mode of the vehicle, the hill-hold mode of the vehicle may be stopped, when the inclination of the slope where the vehicle is positioned is under a predetermined second inclination, a brake-on signal is sensed, or a vehicle speed is over a predetermined second reference speed.

The present invention provides a system for preventing overheating of a clutch by means of forcible creeping.

According to various other aspects of the present invention, there is provided a system for preventing overheating of a clutch by means of forcible creeping that includes: a data storage unit keeping vehicle information for controlling the forcible creeping of the vehicle and an inclination of a slope where the vehicle is positioned; and a controller determining whether to maintain a hill-hold mode of the vehicle based on data from the data storage unit and starting an uphill creeping mode of the vehicle, when the inclination of the slope of the vehicle maintained in the hill-hold mode is less than a predetermined reference inclination in the hill-hold mode.

The controller may decide to maintain the hill-hold mode of the vehicle based on the data from the data storage unit, when the inclination of the slope where the vehicle is positioned is over a first reference inclination, a brake-off signal and an accelerator-on signal are sensed, and the vehicle runs under a first reference speed over a predetermined time.

The controller may compare the inclination of the slope where the vehicle is positioned, which is based on the data from the data storage unit, with the predetermined reference inclination and warn a driver with a sound for preventing the overheating of the clutch, when the inclination of the slope is larger than the reference inclination.

The controller may stop the hill-hold mode of the vehicle, when the inclination of the slope where the vehicle is positioned is under a predetermined second inclination, a brake-on signal is sensed, or a vehicle speed is over a predetermined second reference speed, after warning the driver with the sound generated by vibration of the vehicle.

The controller may cause predetermined torque to be transmitted to a transmission, when starting the uphill creeping mode of the vehicle.

The controller may stop the hill-hold mode of the vehicle, when the inclination of the slope where the vehicle is positioned is under a predetermined second inclination, a brake-on signal is sensed, or a vehicle speed is over a predetermined second reference speed, after starting the uphill creeping mode.

According to the method and system for preventing overheating of a clutch by means of forcible creeping of the present invention, it is possible to achieve various effects, including improvement of a problem with a commercial value of a vehicle, when the vehicle rolls backward on an uphill road by disengaging a clutch to prevent overheating of the clutch and prevention of overheating of a clutch by starting a forcible creeping mode to lead a driver to depress a brake pedal, when a vehicle in a hill-hold mode.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a general flowchart illustrating an exemplary method of preventing overheating of a clutch by means of forcible creeping according to the present invention;

FIG. 2 is a detailed flowchart illustrating an exemplary method of preventing overheating of a clutch by means of forcible creeping according to the present invention; and

FIG. 3 is a diagram showing a configuration of an exemplary system for preventing overheating of a clutch by means of forcible creeping according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

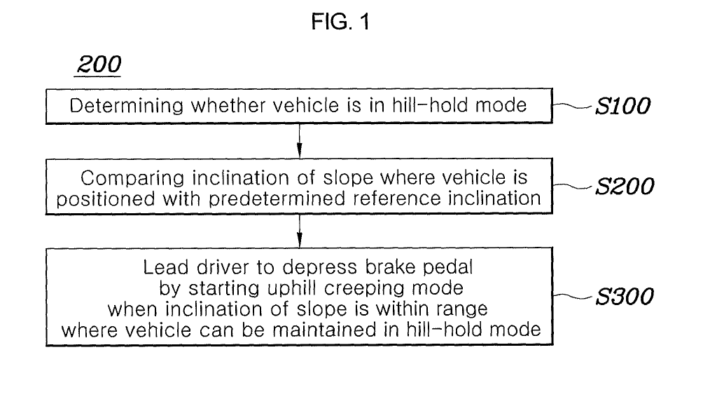

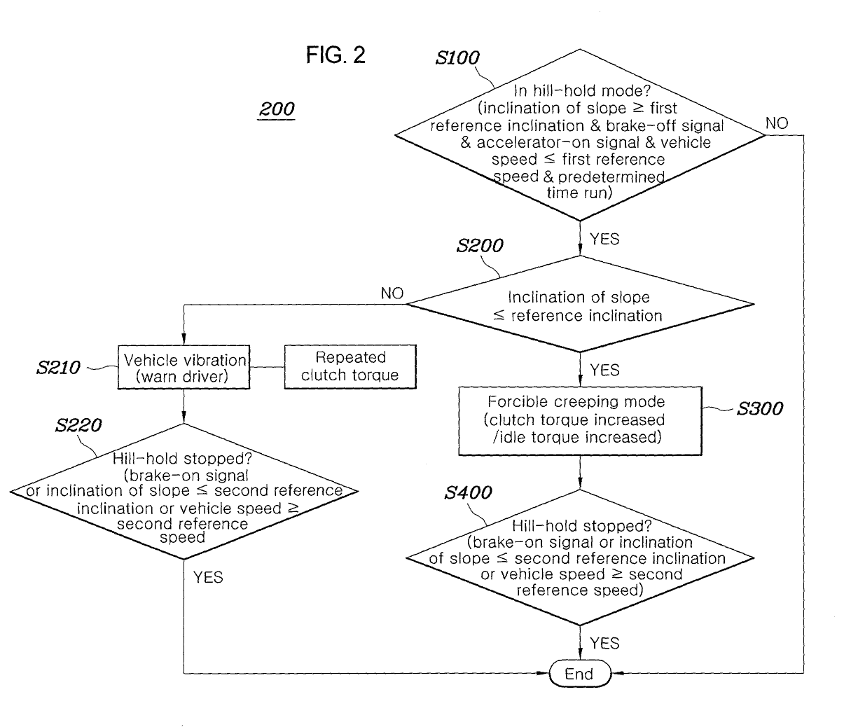

FIGS. 1 and 2 are a general flowchart and a detailed flowchart illustrating a method of preventing overheating of a clutch according to various embodiments of the preset invention. As shown in the flowcharts, the method includes: determining, by a controller 200, whether a vehicle is now in a hill-hold mode (S100); comparing, by the controller 200, the inclination of the slope where the vehicle is with a predetermined reference inclination (S200); and leading, by the controller 200, a driver to depress a brake pedal by starting an uphill creeping mode when the inclination of the slope is within a range where the vehicle can be maintained in the hill-hold mode (S300).

First, it is determined whether a vehicle is now in a hill-hold mode to be prevented from rolling backward on an uphill road having a predetermined inclination (S100).

That is, this is because there is no need for executing the forcible creeping of the present invention, when a vehicle runs normally or on a downhill road without a need to maintain a hill-hold mode to be prevented from rolling back on an uphill road having a predetermined inclination.

In order to determine whether a hill-hold mode is maintained, the present invention determines that the vehicle is now in a hill-hold mode, when a brake-off signal and an accelerator-off signal are sensed and the vehicle runs under a first reference speed for a predetermined time on a slope having an inclination over a predetermined first reference inclination, in the determining of whether a vehicle is in a hill-hold mode (S100).

The first reference inclination, the first reference speed, and the predetermined time are reference values set in advance and they may be set to various values in accordance with the driving states of a vehicle.

In the present invention relating to a method and a system for preventing overheating of a clutch, when a driver maintains a hill-hold state by depressing only an accelerator pedal without depressing a brake pedal on an uphill road having a predetermined inclination, when whether it is a hill-hold mode is determined, it is determined that it is a hill-hold mode when an accelerator pedal is depressed without a brake pedal depressed.

Further, it is determined that a vehicle is now in a hill-hold mode to be prevented from rolling backward on an uphill road, when the vehicle runs under the first reference speed over a predetermined time with the conditions described above satisfied.

That is, when any one of the conditions is not satisfied, it is determined that the vehicle is not in a hill-hold mode now on an uphill road, but the vehicle is running normally or on a downhill road, there is no need for executing the forcible creeping of the present invention.

Whether a brake pedal is depressed or not may be detected by a brake pedal position switch and the vehicle speed may be detected by a speed sensor, which may be mounted on a wheel of the vehicle or may calculate a vehicle speed on the basis of a GPS signal received by a GPS (Global Positioning System), and the inclination of a slope may also be detected by a slope sensor.

When it is determined that a vehicle is now in a hill-hold mode to be prevented from rolling backward on an uphill road having a predetermined inclination, it is determined whether an inclination of a slope where the hill-hold state can be maintained by uphill creeping is smaller than a reference inclination (S200).

That is, a vehicle does not roll backward at an inclination under the limit that the driving force at the creeping speed, which is the speed of the vehicle running with the engine idling on a flatland, can overcome, but the drive has to depress the brake pedal to prevent the vehicle from rolling backward on a slope having an inclination over the driving force, so it is determined that it is a kind of gentle slope where a vehicle can be maintained in a hill-hold state without rolling backward by creeping.

When it is a rapid or steep slope of which the inclination is larger than a predetermined reference inclination, a vehicle vibrates due to repeated clutch torque and a driver is warned by an alarm generated by the vibration (S210).

In this case, the vehicle is prevented from rolling backward on an uphill road by leading the driver to depress the brake pedal or accelerator pedal over a predetermined speed, in addition to warning the driver to prevent the vehicle from rolling backward, in which it is considered that the vehicle cannot be maintained in the hill-hold state, so the control logic of the present invention is ended.

The present invention executes a control logic as well which warns a driver with a sound generated by vibration of a vehicle in accordance with the inclination of a slope, as described herein.

Further, the method includes stopping the hill-hold mode of a vehicle (S220), when the inclination of the slope where the vehicle is positioned under a predetermined second reference inclination, a brake-on signal is sensed, or the vehicle speed is over a predetermined second reference speed, after warning a driver with a sound generated by vibration of a vehicle (S210).

That is, when the inclination is under the second reference inclination, it means that the vehicle runs on a flatland or a downhill road, and when a brake-on signal intended by the driver is sensed or when the vehicle speed is over the second reference speed, it is determined that the driver has no intention of maintaining the hill-hold state anymore, so the control logic of the present invention is ended and the vehicle starts running in a normal driving mode.

Alternatively, when the vehicle is now in a hill-hold mode and the inclination of a slope is under a predetermined reference inclination, forcible creeping mode is started (S300).

In the forcible creeping mode, predetermined torque is transmitted to a transmission and the driver is led to depress the brake pedal.

That is, a signal for increasing the torque of the clutch and a signal for increasing idle torque are transmitted to the clutch, and as described herein, the idle torque is torque that is transmitted to a transmission such that a vehicle runs slow, keeping a low speed, without rolling backward, even though the accelerator pedal and the brake pedal are not depressed. Accordingly, if a vehicle rolls backward on an uphill road even if the torque is transmitted, the driver would depress the brake pedal. Therefore, the driver is naturally led to depress the brake pedal.

By means of this control, it is possible to prevent a driver from suddenly depressing a brake pedal, when a vehicle rolls backward due to forcible disengagement of a clutch in the related art, and a problem with the commercial value of a vehicle due to backward rolling of the vehicle can be solved by the present invention.

The method further includes stopping the hill-hold mode of a vehicle, when the inclination of the slope where the vehicle is positioned is under the second reference inclination, a brake-on signal is sensed, or the vehicle speed is over the second reference speed (S400), after starting of an uphill creeping mode of a vehicle.

As described herein, the control logic is ended, when a driver has no intention of maintaining a hill-hold mode anymore.

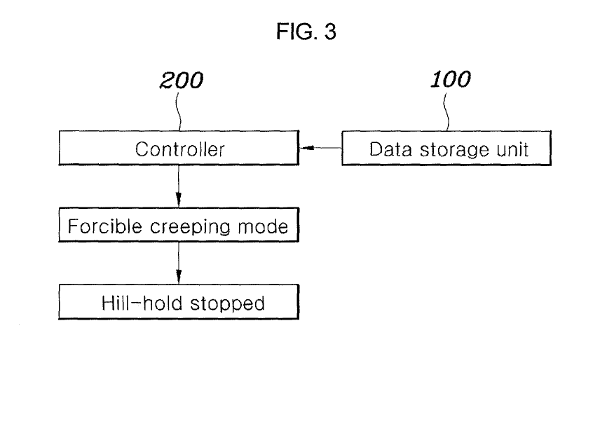

FIG. 3 is a diagram showing the entire configuration of a system for preventing overheating of a clutch by means of forcible creeping according to various embodiments of the present invention. As shown in FIG. 3, the system includes a data storage unit 100 that keeps vehicle information for controlling forcible creeping of a vehicle and the inclination of the slope where a vehicle is positioned now and a controller 200 that determines whether to maintain a hill-hold mode of a vehicle on the basis of the data from the data storage unit and then starts an uphill creeping mode of a vehicle, when the inclination of the slope of the vehicle maintained in a hill-hold mode now is less than a predetermined reference inclination.

The controller 200 decides to maintain the hill-hold mode of a vehicle on the basis of data detected from the data storage unit 100, when the inclination of a slope where the vehicle is positioned now is over the first reference inclination, a brake-off signal and an accelerator-on signal are sensed, and the vehicle runs under the first reference speed over a predetermined time.

Further, the controller compares the inclination of the slope where a vehicle is positioned now, which is detected from the data storage unit 100, with a predetermined reference inclination and then warns a driver with a sound for preventing overheating of a clutch, when the inclination of the slope is larger than the reference inclination.

The controller 200 stops the hill-hold mode of a vehicle, when the inclination of the slope where the vehicle is positioned is under the second reference inclination, a brake-on signal is sensed, or the vehicle speed is over the second reference speed, after warning a drive with a sound generated by vibration of a vehicle. Further, the controller causes predetermined torque to be transmitted to a transmission, when the uphill creeping mode of a vehicle is started.

Further, the method stops the hill-hold mode of a vehicle, when the inclination of the slope where the vehicle is positioned is under the second reference inclination, a brake-on signal is sensed, or the vehicle speed is over the second reference speed, after starting an uphill creeping mode of a vehicle.

The process of controlling the system for preventing overheating of a clutch by means of forcible creeping of the present invention has been described already, so it is not described anymore.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of preventing overheating of a clutch by means of forcible creeping, the method comprising:
determining, by a controller, whether a vehicle is in a hill-hold mode;
comparing, by the controller, an inclination of a slope where the vehicle is with a predetermined reference inclination; and
leading, by the controller, a driver to depress a brake pedal by starting an uphill creeping mode, when the inclination of the slope is within a range where the vehicle is maintained in the hill-hold mode.

2. The method of claim 1, wherein in the determining of whether the vehicle is in the hill-hold mode, it is determined that the vehicle is in the hill-hold mode, when a brake-off signal and an accelerator-on signal are sensed and the vehicle runs under a predetermined first reference speed over a predetermined time on the slope having the inclination over a predetermined first reference inclination.

3. The method of claim 1, wherein in the comparing of the inclination of the slope where the vehicle is with the predetermined reference inclination, the driver is warned by a sound for preventing the overheating of the clutch, when the inclination of the slope where the vehicle is positioned is larger than the reference inclination.

4. The method of claim 3, wherein after the driver is warned by the sound generated by vibration of the vehicle, the hill-hold mode of the vehicle is stopped, when the inclination of the slope where the vehicle is positioned is under a predetermined second inclination, a brake-on signal is sensed, or a vehicle speed is over a predetermined second reference speed.

5. The method of claim 1, wherein in the starting of the uphill creeping of the vehicle, predetermined torque is transmitted to a transmission and the driver is led to depress the brake pedal.

6. The method of claim 5, wherein after the starting of the uphill creeping mode of the vehicle, the hill-hold mode of the vehicle is stopped, when the inclination of the slope where the vehicle is positioned is under a predetermined second inclination, a brake-on signal is sensed, or a vehicle speed is over a predetermined second reference speed.

7. A system for preventing overheating of a clutch by means of forcible creeping, the system comprising:
a data storage unit keeping vehicle information for controlling the forcible creeping of a vehicle and an inclination of a slope where the vehicle is positioned; and
a controller determining whether to maintain a hill-hold mode of the vehicle based on data from the data storage unit and starting an uphill creeping mode of the vehicle, when the inclination of the slope of the vehicle maintained in the hill-hold mode is less than a predetermined reference inclination in the hill-hold mode.

8. The system of claim 7, wherein the controller decides to maintain the hill-hold mode of the vehicle based on the data from the data storage unit, when the inclination of the slope where the vehicle is positioned is over a first reference inclination, a brake-off signal and an accelerator-on signal are sensed, and the vehicle runs under a first reference speed over a predetermined time.

9. The system of claim 7, wherein the controller compares the inclination of the slope where the vehicle is positioned, which is based on the data from the data storage unit, with the predetermined reference inclination and warns a driver with a sound for preventing the overheating of the clutch, when the inclination of the slope is larger than the reference inclination.

10. The system of claim 9, wherein the controller stops the hill-hold mode of the vehicle, when the inclination of the slope where the vehicle is positioned is under a predetermined second inclination, a brake-on signal is sensed, or a vehicle speed is over a predetermined second reference speed, after warning the driver with the sound generated by vibration of the vehicle.

11. The system of claim 7, wherein the controller causes predetermined torque to be transmitted to a transmission, when starting the uphill creeping mode of the vehicle.

12. The system of claim 11, wherein the controller stops the hill-hold mode of the vehicle, when the inclination of the slope where the vehicle is positioned is under a predetermined second inclination, a brake-on signal is sensed, or a vehicle speed is over a predetermined second reference speed, after starting the uphill creeping mode.
